(19) United States
(12) Patent Application Publication
(10) Pub. No.: US 2010/0190930 A1
(43) Pub. Date: Jul. 29, 2010

(54) BLOCK COPOLYMER COMPOSITION AND USE THEREOF IN A PROJECTION DEVICE

(76) Inventors: Sylvain Bourrigaud, Pau (FR); Pierre Gerard, Denguin (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/528,341

(22) PCT Filed: Feb. 19, 2008
(86) PCT No.: PCT/FR2008/050271

§ 371 Date: Apr. 13, 2010

(30) Foreign Application Priority Data
Feb. 23, 2007 (FR) 0753446

(51) Int. Cl. C08L 53/00

(52) U.S. Cl. 525/94

(57) ABSTRACT

The invention relates to a composition that contains, in weight and for a total of 100%: from 10 to 40% of a block copolymer including a central block B with Tg<0° C. and at least two side rigid blocks A and A′ with Tg>0° C. that include MAM as a main monomer as well as patterns derived from (meth)acrylic acid and/or anhydrous groups of the formula (I) in which R1 and R2 are H or a methyl radical; from 90 to 60% of at least one PMMA. The invention also relates to the use of such a composition for making a transparent protection part for a projector, and to the projecting device itself.

### TECHNICAL FIELD

The present invention relates to a novel transparent composition that can be used in the field of projector devices for motor vehicles (headlights). It also relates to a projector device itself.

### TECHNICAL PROBLEM

Projector devices for motor vehicles are currently formed from a protective transparent part made of polycarbonate (PC) coated with a UV-resistant and scratch-resistant lacquer. The lacquering step requires investment in a coating line that is expensive and sometimes difficult to control when it is a question of obtaining a uniform distribution of the thickness of the lacquer over parts having a complex shape. The lacquering step also generates a not insignificant manufacturing cost premium. For some time, motor vehicle manufacturers have sought alternative solutions which make it possible to be free from the lacquering step, in order to avoid the technical problems linked to this step and to reduce the manufacturing cost of headlights.

The Applicant has developed a composition which has good enough scratch resistance to not require a lacquering step. The composition developed by the Applicant has, in addition, good thermomechanical strength and also a transparency equivalent to that of PC or PMMA.

### PRIOR ART

International Application WO 03/062293 describes a transparent composition composed of a brittle matrix having T_{g}>0° C., dispersed in which is a block copolymer of formula B(A)ₙ, n being an integer between 2 and 20. The brittle matrix may especially be a PMMA.

International Application WO 2005/090477 describes a transparent composition that can be used for manufacturing a moulded disc comprising from 80 to 100% of at least one block copolymer of formula I-(B)ₙ-(A)ₘ and from 0 to 20% of at least one impact additive.

International Application WO 2006/053984 describes a multilayer structure comprising an intermediate ductile layer comprising a block copolymer of formula BAn.

International Applications WO 2006/100126 and WO 2006/100127 describe a luminous device composed of a scattering transparent part and a light-emitting diode (LED).

None of these documents refer to the use of the composition of the invention for manufacturing projector devices for motor vehicles.

### BRIEF DESCRIPTION OF THE INVENTION

The invention relates to a composition comprising, by weight, the total making 100%:
from 10 to 40% of at least one block copolymer composed of a central block B of T_{g}<0° C. and at least two rigid side blocks A and A′ of T_{g}>0° C. which comprise MMA as a main monomer and also units derived from (meth)acrylic acid and/or anhydride groups of formula:

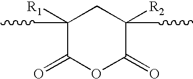

in which R₁ and R₂ denote H or a methyl radical; and
from 90 to 60% of at least one PMMA.

The invention also relates to the use of such a composition for manufacturing a transparent protective part for a projector device.

The invention also relates to a projector device comprising at least one light source and a transparent protective part formed from such a composition.

### DETAILED DESCRIPTION

T_{g} denotes the glass transition temperature of a polymer measured by DSC according to ASTM E1356. The T_{g} of a monomer is also referred to in order to denote the T_{g} of the homopolymer having a number-average molecular weight Mₙ of at least 10000 g/mol, obtained by radical polymerization of said monomer. Thus, it can be said that ethyl acrylate has a T_{g} of −24° C. since the poly(ethyl acrylate) homopolymer has a T_{g} of −24° C. All the percentages are given by weight, except where otherwise mentioned.

The expression “(meth)acrylic monomer M” denotes a monomer which may be:
an acrylic monomer such as an alkyl acrylate, more particularly having a C₁-C₁₀ alkyl group, the alkyl group possibly being linear or branched, primary, secondary or tertiary, cycloalkyl or aryl or alkylaryl such as methyl, ethyl, propyl, n-butyl, isobutyl, text-butyl, or 2-ethylhexyl acrylate, an ether alkyl acrylate such as 2-methoxyethyl acrylate, an aminoalkyl acrylate such as 2-(dimethylamino)ethyl acrylate, a silyl acrylate, glycidyl acrylate or isobornyl acrylate; and
a methacrylic monomer such as an alkyl methacrylate, more particularly having a C₁-C₁₀ alkyl group, the alkyl group possibly being linear or branched, primary, secondary or tertiary, cycloalkyl or aryl or arylalkyl such as methyl methacrylate (MMA), ethyl, propyl, butyl (n-butyl, isobutyl or tert-butyl) or 2-ethylhexyl methacrylate, ether alkyl methacrylates such as 2-methoxyethyl methacrylate, an aminoalkyl methacrylate such as 2-(dimethylamino)ethyl methacrylate, a silyl methacrylate, glycidyl methacrylate or isobornyl methacrylate.

The term “PMMA” denotes a homopolymer or copolymer of methyl methacrylate (MMA), comprising, by weight, at least 50% of MMA. The copolymer is obtained from MMA and at least one comonomer copolymerizable with the MMA. Preferably, the copolymer comprises, by weight, from 70 to 99.5%, advantageously from 80 to 99.5%, preferably from 80 to 99% of MMA per 0.5 to 30%, advantageously 0.5 to 20%, preferably 1 to 20% respectively of comonomer.

Preferably, the comonomer copolymerizable with the MMA is a (meth)acrylic monomer or a vinyl aromatic monomer such as, for example, styrene, substituted styrenes, α-methylstyrene, monochlorostyrene or tent-butylstyrene. Preferably, it is an alkyl (meth)acrylate, especially methyl, ethyl, propyl or butyl acrylate or butyl methacrylate.

Regarding the block copolymer, this is composed of a central block B of T_{g}<0° C. and at least two rigid side blocks A and A′ of T_{g}>0° C. In accordance with the definition given in 1996 by the IUPAC in its recommendations on polymer nomenclature, the expression “block copolymer” is understood to mean a copolymer composed of adjacent blocks that are constitutionally different, that is to say blocks comprising units derived from different monomers or from a same monomer, but having a different composition or sequential distribution of the units. A block copolymer may be, for example, a diblock, triblock or star copolymer.

The block copolymer is, for example, an A-B-A′ triblock copolymer comprising a central block B linked by covalent bonds to two rigid side blocks A and A′ (that is to say positioned on each side of the central block B). A and A′ may be identical or different (this type of copolymer is sometimes also denoted by A-b-B-b-A′).

Preferably, the block copolymer is such that the rigid side block(s) and the block B are incompatible, that is to say that they have a Flory-Huggins interaction parameter χ_{AB}>0 at ambient temperature. This causes a phase microseparation with formation of a two-phase structure at macroscopic level. The block copolymer is then nanostructured, that is to say that it forms areas where the size is less than 100 nm, preferably between 10 and 50 nm. The nanostructuration has the advantage of leading to a material with good transparency regardless of the temperature.

The block copolymer may be obtained using polymerization techniques known to a person skilled in the art. One of these polymerization techniques may be anionic polymerization such as is, for example, taught in the following documents: FR 2762604, FR 2761997 and FR 2761995. It may also be the controlled radical polymerization technique which comprises several variants depending on the nature of the control agent that is used. Mention may be made of SFRP (Stable Free Radical Polymerization) that uses nitroxides T as the control agent and may be initiated by alkoxyamines, ATRP (Atom Transfer Radical Polymerization) that uses metal complexes as the control agent and is initiated by halogenated agents, RAFT (Reversible Addition Fragmentation Transfer) that requires, for its part, sulphur products such as dithioesters, trithiocarbonates, xanthates or dithiocarbamate. It is possible to refer to the general review by Matyjaszewski, K. (Ed.), ACS Symposium Series (2003), 854 (Advances in Controlled/Living Radical Polymerization) and also to the following documents for more details on the controlled radical techniques which may be used: FR 2825365, FR 2863618, FR 2802208, FR 2812293, FR 2752238, FR 2752845, U.S. Pat. No. 5,763,548 and U.S. Pat. No. 5,789,487.

The controlled radical polymerization with control by nitroxides T is the preferred technique for producing the block copolymer of the invention. This is because this technique does not necessitate working under conditions as strict as in anionic polymerization (that is to say, in the absence of moisture and at a temperature <100° C.). It also makes it possible to polymerize a wide range of monomers. It may be carried out under various conditions, for example in bulk, in solvent or in a dispersed medium. Preferably, aqueous suspension polymerization is chosen. The nitroxide T is a stable free radical having an ═N—O. group, that is to say a group in which an unpaired electron is present. A stable free radical denotes a radical that is very long-lasting and is non-reactive with respect to air and to moisture in the ambient air, which may be handled and kept for a much longer time than the majority of free radicals (see, in connection with this, Accounts of Chemical Research, 1976, 9, 13-19). The stable free radical is thus distinguished from free radicals whose lifetime is short-lived (a few milliseconds to a few seconds) such as the free radicals derived from common polymerization initiators such as peroxides, hydroperoxides or azo initiators. The free radical polymerization initiators tend to accelerate the polymerization whereas the stable free radicals generally tend to slow it down. It may be said that a free radical is stable in the sense of the present invention if it is not a polymerization initiator and if, under the normal conditions of the invention, the average lifetime of the radical is at least one minute.

To produce an ABA′ triblock copolymer using the controlled radical polymerization technique, advantageously a difunctional alkoxyamine of formula T-Z-T may be used. To start with the central block B is prepared by polymerizing, using the alkoxyamine, the blend of monomers leading to the central block. The polymerization takes place with or without solvent, or else in a disperse medium. The blend is heated at a temperature above the activation temperature of the alkoxyamine. When the central block B is obtained, the monomers) leading to the side blocks is (are) added. It could be that at the end of the preparation of the central block, some monomers that have not been completely consumed remain that it may or may not be chosen to remove before the preparation of the side blocks. The removal may consist, for example, in precipitating in a nonsolvent, recovering and drying the central block. If it is chosen not to remove the monomers that have not been completely consumed, these may polymerize with the monomers introduced to prepare the side blocks. Found in the following documents WO 2006/053984 or WO 03/062293 are examples of preparing block copolymers by controlled radical polymerization. When the polymerization begins with the formation of the block B, the two side blocks A and A′ are identical in terms of composition and average molecular weight (the block copolymer therefore has the formula ABA).

Examples of Block Copolymers that can be Used

The copolymers were obtained by the controlled radical polymerization technique in a solvent medium using a difunctional alkoxyamine such as DIAMINS described on page 27 of Application WO 2006/053984.

TABLE 1

| | | | M_{w} of | | | | |
|---|---|---|---|---|---|---|---|
| | | | the | Composition | | | M_{w} of the |
| | Composition | Butyl | central | of the blocks | | | ABA′ |
| | of the | acrylate | block B | A and A′ | MMA | Methacrylic | copolymer |
| Copolymer | central block B | content* | [g/mol] | (identical) | content* | acid content* | [g/mol] |
| 1 | butyl | 37% | 29000 | MMA/methacrylic | 60% | 3% | 113000 |
| | acrylate only | | | acid | | | |
| 2 | butyl | 37% | 29000 | MMA/methacrylic | 57% | 6% | 115000 |
| | acrylate only | | | acid | | | |
| 3 | butyl | 32% | 29000 | MMA/methacrylic | 61% | 7% | 120000 |
| | acrylate only | | | acid | | | |
| 4 | butyl | 20% | 29000 | MMA/methacrylic | 72% | 8% | 144000 |
| | acrylate only | | | acid | | | |
| 5 | butyl | 13% | 29000 | MMA/methacrylic | 79% | 8% | 190000 |
| | acrylate | | | acid | | | |
| | only | | | | | | |

*overall contents in wt % in the copolymer
M_{w}: weight-average molecular weight (relative to a PMMA standard)

Regarding the central block B, this has a T_{g}<0° C. The number-average molecular weight Mₙ is between 10000 and 1000000 g/mol, preferably between 20000 and 50000 g/mol (relative to a PMMA standard). The weight proportion of the central block B in the block copolymer is between 5 and 50%.

The central block B mainly comprises at least one (meth)acrylic monomer having a T_{g}<0° C. For example, use is advantageously made of butyl acrylate which has a T_{g}<0° C. and which is polymerized very well by the controlled radical polymerization technique using a nitroxide. It also makes it possible to give the block copolymer a good impact strength.

Regarding the side blocks A and A′, these have a T_{g}>0° C., comprising MMA as the main monomer and also units derived from (meth)acrylic acid. The number-average molecular weight Mₙ is between 5000 and 900000 g/mol (relative to a PMMA standard). The weight proportion of side blocks A and A′ in the block copolymer is between 50 and 95%.

The units derived from (meth)acrylic acid improve the scratch resistance and also the thermomechanical (VICAT) behaviour of the block copolymer. The side blocks A and A′ each comprise, by weight, from 70 to 99% of methyl methacrylate (MMA), from 0 to 10% of a comonomer copolymerizable with the MMA and from 1 to 30% of acrylic and/or methacrylic acid. Preferably, they advantageously comprise from 85 to 90% of MMA, from 0 to 10% of a comonomer copolymerizable with the MMA and from 10 to 15% of acrylic and/or methacrylic acid. The copolymerizable comonomer may be, for example, styrene or a (meth)acrylic monomer.

Regarding the composition, this comprises, by weight, the total making 100%:
from 10 to 40% of at least one block copolymer; and
from 90 to 60% of at least one PMMA.

The composition must have sufficient mechanical strength (rigidity) to be used in the field of projector devices. It must have a flexural modulus >1000 MPa, advantageously >2000 MPa. The blend is obtained using any technique for blending thermoplastics that is known by a person skilled in the art, for example by extrusion.

Two adjacent acid units of acrylic or methacrylic acid present in one or other of the side blocks or else in the PMMA may react together by dehydration to give an anhydride group of formula:

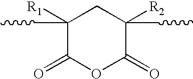

in which R₁ and R₂ denote H or a methyl radical. The dehydration is obtained, for example, by heating, optionally under vacuum.

The PMMA could advantageously be a copolymer of MMA and acrylic and/or methacrylic acid. This type of PMMA gives improved thermomechanical strength and also scratch resistance relative to a PMMA that does not contain any. Thus, for example, ALTUGLAS® HT 121 sold by Altuglas International that comprises, by weight, 95-96% of MMA and 4-5% of methacrylic acid functional groups and anhydride functional groups derived from the preceding functional groups has a Rockwell hardness of M-102 and also a VICAT softening point of 121° C. (according to ISO 306).

The composition could comprise additives commonly used in the plastics industry. For example, it could comprise a dye and/or a pigment in order to colour the protective part for the projector device.

Regarding the projector device, this comprises at least one light source and a transparent protective part formed from the composition of the invention. The light source may be, for example, an incandenescent light bulb, a discharge light bulb, a halogen light bulb or else a light-emitting diode (LED). The protective part has the role of protecting the light source (against impacts and dust) while being transparent to the luminous flux from the light source. The protective part may be planar or else have a more or less rounded shape depending on the shape of the projector device. The protective part may have a thickness between 0.5 and 10 mm, preferably between 1 and 5 mm. It may be manufactured, for example, by the injection-moulding technique.

### EXAMPLES

The copolymers 1, 2 and 3 described in Table I were melt-blended by extrusion at 30 wt % with ALTUGLAS® HT121 (70 wt %) to respectively give the blends 1, 2 and 3. The copolymers 4 and 5 were characterized as they were. The product HT121 served as a reference and was denoted by Reference 1. The PC LEXAN® 141 polycarbonate from GE Plastics was also used as a reference (Reference 2).

### Tests Carried Out

The viscosity of the various products was measured using a Rosand RH7 capillary rheometre at 230° C. and was expressed in Pa·s for a shear rate of 100 s⁻¹. The flexural modulus was measured according to the standard ISO 178 (flexural modulus or FM, expressed in MPa). Tensile tests were carried out according to the standard ISO 527-2. The yield stress, σ_{y} (in MPa) and the percentage strain at break, % break) were measured. The optical properties were measured according to the standard ASTM D 1003 (Haze in % and total transmission, TT in %, for parts having a thickness of 2 mm). The gloss of the samples was characterized according to the standard ASTM D 523 (60° gloss measurement). The thermal properties were evaluated by measurement of the Vicat softening point according to the standard ISO 306.

The impact properties were evaluated according to an internal falling ball test. The operating conditions of the trial using a 50 gram ball were the following:
ball diameter: 12.8 mm;
drop height: 50 cm;
the 2 mm thick part was simply placed on a support adapted to its diameter;
the 50 g ball was dropped from a height of 50 cm; and
10 parts were tested per trial.

The results were expressed in terms of broken parts (denoted as B), cracked parts (denoted by C) and intact, uncracked parts (denoted by UC).

The scratch properties were evaluated from the Erichsen scratch resistance measurement according to the standard NFT 51113, using a tungsten carbide tip on which a load of 2 N was applied with a rotational speed of 10.5 mm/s. Next, the width of the scratched groove was measured and the result of the test was then expressed in microns. An additional test was carried out by the so-called pencil test method according to the standard ASTM D3363. The abrasion properties were evaluated according to the standard ASTM D 1044 in a Taber test. The result was expressed in terms of variation of haze (loss of transparency, expressed in %) at the end of a stress of 500 revolutions of an abrasive wheel (reference S cs 10F) relative to the unstressed material.

The products of the invention (blend 1 to 3 and copolymer 4 and 5) have a lower viscosity than Reference 2 (PC) therefore an improved fluidity during their forming. They are also mechanically stronger than the Reference 1 and have better scratch and abrasion behaviour than Reference 2. The transparencies of blends 2 to 3 is of the same order of magnitude as the two reference products.

TABLE II

| | | Flexural | | | | | 60° | | | | | |
|---|---|---|---|---|---|---|---|---|---|---|---|---|
| Product | Viscosity | modulus | σ_{y} | % break | Haze | TT | gloss | Vicat | Falling | Erichsen | Pencil | Abrasion |
| tested | [Pa · s] | [MPa] | [MPa] | [%] | [%] | [%] | (G.U.) | [° C.] | ball | [μ] | test | [%] |
| Ref 1 | 1260 | 3790 | — | 1.6 | 0.55 | 93.6 | 110 | 119 | B | 77 | 5H | 33 |
| Ref 2 | 3410 | 2400 | — | — | — | — | — | | UC | 137 | HB | >60 |
| Blend 1 | 850 | 3290 | — | 3.0 | 1.45 | 92.3 | 109 | 116 | B | 80 | 4H | 29 |
| Blend 2 | 930 | 3280 | — | 3.9 | 1.30 | 92.5 | 110 | 116 | B | 81 | 4H | 29 |
| Blend 3 | 980 | 3220 | — | 4.8 | 1.08 | 92.5 | 110 | 116 | B | 84 | 4H | 33 |
| Copo. 4 | 1200 | 2400 | 50 | 18.2 | 2.41 | 87.5 | 103 | 120 | UC | 92 | 3H | 55 |
| Copo. 5 | 2230 | 2850 | 58 | 12.4 | 3.33 | 89.4 | 107 | 117 | C | 86 | 4H | 43 |

1. Composition comprising, by weight, the total making 100%:
from 10 to 40% of at least one block copolymer composed of a central block B of T_{g}<0° C. and at least two rigid side blocks A and A′ of T_{g}>0° C. which comprise at least 50% by weight methyl methacrylate (MMA) units and also units derived from (meth)acrylic acid and/or anhydride groups of formula: 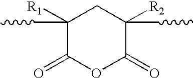
in which R₁ and R₂ denote H or a methyl radical; and
from 90 to 60% of at least polymethyl methacrylate (PMMA).

2. Composition according to claim 1, in which the block copolymer has the formula ABA′.

3. Composition according to claim 1, in which the central block B comprises 50 percent or more by weight of at least one (meth)acrylic monomer having a T_{g}<0° C.

4. Composition according to claim 3, in which the (meth)acrylic monomer of block B is butyl acrylate.

5. Composition according to claim 1, in which the side blocks A and A′ each comprise, by weight, from 70 to 99% of methyl methacrylate (MMA), from 0 to 10% of a comonomer copolymerizable with the MMA and from 1 to 30% of acrylic and/or methacrylic acid.

6. Composition according to claim 5, in which the comonomer copolymerizable with the MMA is styrene or a (meth)acrylic monomer.

7. Composition according to claim 1, in which the PMMA, as a mixture with the block copolymer, is a homopolymer or copolymer of methyl methacrylate (MMA) comprising, by weight, at least 50% of MMA.

8. Composition according to claim 7, in which the PMMA is a copolymer of MMA and acrylic and/or methacrylic acid.

9. (canceled)

10. The composition according to claim 1, comprising a transparent protective part for a projector device.

11. The composition of claim 10 wherein said projector device comprises at least one light source.
